(19) United States
(12) Patent Application Publication
(10) Pub. No.: US 2008/0021971 A1
(43) Pub. Date: Jan. 24, 2008

(54) System and Method for Electronic Messaging Notification Using End-User Display Devices

(76) Inventor: Joseph F. Halgas, Huntingdon Valley, PA (US)

Correspondence Address: Motorola, Inc.;Law Department, 1303 East Algonquin Road, 3rd Floor, Schaumburg, IL, 60196, US

(21) Appl. No.: 11/459,165

(22) Filed: Jul. 21, 2006

(51) Int. Cl. G06F 15/16

(52) U.S. Cl. 709/207; 709/203

(57) ABSTRACT

A system (10) and method (50) for notifying an end-user display device of the receipt of an electronic message by an electronic messaging system coupled to a computing device coupled to the end-user display device. The system (10) includes a computing device, such as a personal computer (12) or other suitable computing device, and an end-user display device (14) coupled to the computing device and to one or more other devices, such as audio/video devices (44). The method (50) includes generating a notification of the receipt of an electronic message in response to the electronic messaging system receiving an electronic message. The method (50) also includes transmitting the notification to the end-user display device (14) and the end-user display device (14) displaying an alert message corresponding to the notification when the end-user display device (14) is displaying video content from a video input source other than the computing device (12)

### BACKGROUND OF THE INVENTION

1. Field of the Invention

The invention relates to end-user display devices, such as televisions. More particularly, the invention relates to electronic messaging notification using end-user display devices.

2. Description of the Related Art

The emergence of the high definition television (HDTV) and other end-user display devices with improved resolution has allowed such devices to be more readily connectable to personal computer (PC) systems and other computing devices. With the ability of HDTVs and other end-user, display devices to support high-definition resolutions and progressive scan display modes, personal computers and other computing systems can be connected to such end-user display devices with greater usability and viewability than was previously possible with televisions designed for displaying content in accordance with the National Television System Committee (NTSC). Accordingly, many of these end-user display devices are being manufactured with both analog and digital RGB (red-green-blue) inputs to allow specifically for connection with PCs and other computing systems,

Along with the rise in popularity of HDTVs and other high resolution end-user display devices, the adoption of broadband and other high-speed Internet access has steadily increased. With a broadband Internet connection, consumer end-users essentially have full-time access to uninterrupted high-speed Internet connectivity. As a result of this convenience, the use of electronic mail (email) messaging, instant messaging (IM), electronic chat and other electronic messaging applications has greatly increased

Many end-users have both a personal computer and a television tuner, such as a high definition tuner, connected to their high resolution end-user display device Also, such high resolution end-user display devices typically are capable of accepting video inputs from many other sources, including signal converter or decoder (set-top) boxes, personal video recorders (PVRs), digital video disc (DVD) players, videocassette recorders (VCRs), gaming consoles, camcorders, and other suitable video (and audio) receivers. By switching between the input sources connected to their end-user display device, end-users can watch a television program or a recorded video program, play a video game, or perform any number of PC-related computing activities, including email and IM activities and Internet browsing. However, with the end-user display device serving as a single display device for video content viewing, including television viewing, and personal computing, end-users typically have to switch from a video content viewing input source to the personal computing input source to know if electronic messages have been received.

### BRIEF DESCRIPTION OF THE DRAWINGS

FIG. 1 is a block diagram of an electronic messaging notification system for end-user display devices;

FIG. 2 is a flow chart of an electronic messaging notification method for end-user display devices;

FIG. 3 is a block diagram of an another electronic messaging notification system for end-user display devices;

FIG. 4 is a diagram of a display screen displaying video content without electronic messaging notification; and

FIG. 5 is a diagram of a display screen displaying video content with electronic messaging notification.

### DETAILED DESCRIPTION

In the following description, like reference numerals indicate like components to enhance the understanding of the electronic messaging notification system and method through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention

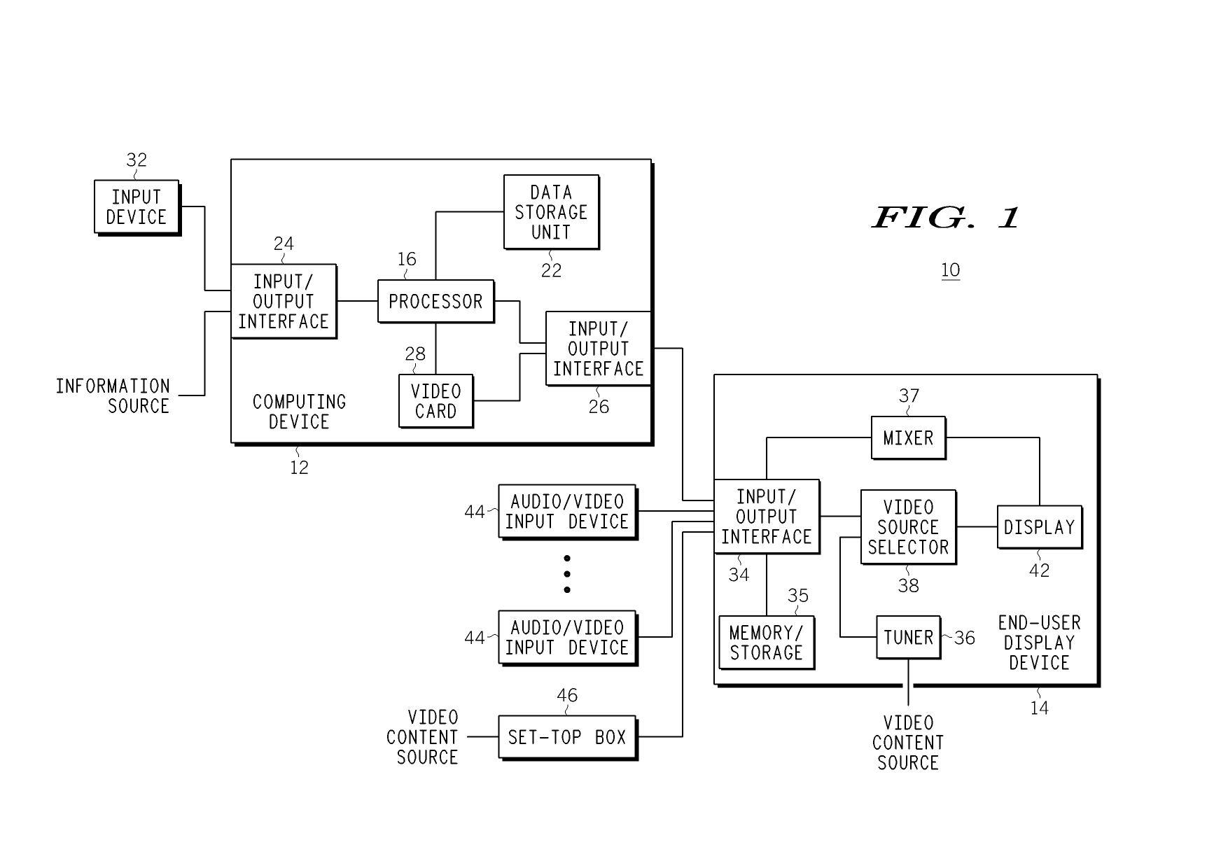

Referring now to FIG. 1, shown is a block diagram of an electronic messaging notification system 10 for end-user display devices. The system 10 includes a computing device 12 and an end-user display device 14. The computing device 12 can be completely or partially any suitable computing system, subsystem, or device, e.g., a personal computer (PC), including a desktop PC or a laptop PC. The computing device 12 also can be any suitable data/video content/information processing device that has included therein computing capabilities, such as a residential gateway, a signal converter or decoder (set-top) box, a digital video recorderd and a home media server.

The computing device 12 typically includes a processor 16 for processing information received by and transmitted from the computing device 12, at least one type of memory storage unit or data storage unit 22 coupled to the processor for storing processing instructions and information received by the computing device 12. The processor 16 can be completely or partially configured in the form of hardware circuitry and/or other hardware components within a larger device or group of components. Alternatively, the processor 16 can be completely or partially configured in the form of software e.g., as processing instructions or one or more sets of logic or computer code. In such configuration, the logic or processing instructions typically ate stored in the storage unit 22. The processor 16 accesses the necessary instructions from the storage unit 22 and executes the instructions or transfers the instructions to the appropriate location within the computing device 12. Also, although the storage unit 22 is shown within the computing device 12, the storage unit 22 can be located external to the computing device 12 and suitably coupled thereto

The computing device 12 also typically includes an input/output (I/O) interface 24 coupled to the processor 16, an input/output (I/O) interface 26 coupled to the processor 16 and a video card 28 coupled to the processor 16 and the I/O interface 26. The video card 28 produces the visual output from the computing device 12. Because of the nature of video content output from computing devices, the video card 28 may include built-in processing capabilities.

The I/O interface 24 receives information from an appropriate information source, e.g., via an Internet connection, an electronic messaging system connection, and/or a suitable networking connection. Also, the I/O interface 24 is suitable for connection to one or more input devices 32, such as end-user input devices, which allow a user of the computing device 12 to input information into the computing device 12 and/or request information from the computing device 12. For example, suitable end-user input devices include a keyboard and a mouse. The I/O interface 26 transmits information from the computing device 12 to an appropriately-connected device, such as the end-user display device 14.

Any one or more of the components in the computing device 12 can be comprised of any suitable structure or arrangement, e.g., one or more integrated circuits. Also, it should be understood that the computing device 12 includes other components, hardware, and software (not shown) that are used for the normal operation of features and functions of the computing device 12 not specifically described herein.

The end-user display device 14 is any end-user display device that has a resolution suitable for connecting to and displaying video content from the computing device 12. For example, as discussed hereinabove, the end-user display device 14 is a television, such as a high definition television (HDTV) or other high-resolution television. The end-user display device 14 typically includes an input/output (I/O) interface 34, a memory or data storage unit 35 coupled to the I/O interface 34, a tuner 36, a mixer 37 coupled to the I/O interface 34, a video source selector 38 coupled to the I/O interface 34 and the tuner 36, and a display or display unit or monitor 42 coupled to the video source selector 38 and the mixer 37.

As discussed hereinabove, the end-user display device 14 typically is configured to accept video inputs from many sources. Therefore, typically, the I/O interface 34 often has connected thereto one or more audio/video (A/V) sources or video input devices 44, e.g., a personal video recorder (PVR), a digital video disc (DVD) player, a videocassette recorder (VCR), a gaming console, a camcorder, a video (and audio) receiver, and other suitable A/V sources. Also, the I/O interface 34 typically has connected thereto a television signal, e.g., received horn a signal converter or decoder (set-top) box 46 or other appropriate television signal source, e.g., a television service provider (e g., a national or local television network), a cable television service provider, an Internet service provider, a satellite broadcast system service provider, or other suitable service provider.

The memory or data storage unit 35 can store message notification data or information, such as icons or other indicia, that is used to notify an end user viewing the end user display device 14, as will be discussed in greater detail hereinbelow. Also, the memory or data storage unit 35 can store processing instructions and other information used by the end user display device 14.

The tuner 36 tunes the end-user display device 14 to a specific channel, e.g., for use in delivering specific video content to the display monitor 42. The tuner 36 receives information from an appropriate source, typically a television signal source, such as from a broadcast television service provider (e.g., a national or local television network), a cable television service provider, or a satellite broadcast system service provider. The mixer 37 mixes, e g., overlays, message notification indicia with the video content being displayed on the display monitor portion of the end-user display device 14, as will be discussed in greater detail hereinbelow.

The video source selector 38, which is coupled to both the I/O interface 34 and the tuner 36, selects a single video source for display by the display monitor 42. The video source selected for display by the video source selector 38 typically is chosen by an end-user; e.g., via a remote control device (not shown) used to operate the video source selector 38 and other features and functions of the end-user display device 14.

As discussed hereinabove, with the improved resolution of end-user display devices, computing devices have joined the list of A/V or video input sources that typically are connected to one of the many video inputs to the end-user display device. Therefore, when the appropriate input source selection is made on the end-user display device, the end-user display device can be used as a computer monitor for the computing device. In this manner an end user can perform any number of PC-related computing activities using an end-user display device as the computer's monitor.

In such arrangement, the end-user display device becomes the single video display device for a number of video input devices, including computing devices. As discussed previously hereinabove, by switching between the input sources connected to their end-user display device, end-users can perform PC-related computing activities, such as email messaging and instant messaging (IM) activities and browsing the Internet, and also watch a television program or a recorded video program, playback the contents of a camcorder, or play a video game. However, because the end-user display device typically displays video from only one video input source, end users must switch between video input sources to view the video content from more than one video input source.

Thus, for example, if an end user is watching a television program and wants to check whether any electronic messages have been received by an electronic messaging system connected to or residing in the end-user's personal computer, the end user typically has to switch the video input source to the end-user display device from the television program to the personal computer. Moreover, switching between video input sources in this manner may not be convenient, if, rather than directly switching between video input sources, the end user has to cycle through all of the connected video sources before arriving at the desired video input source.

The electronic messaging notification system 10 for end-user display devices provides a notification or alert, such as a “message waiting” notification, icon or other indicia, that can be noticed by an end user viewing the end-user display device 14, regardless of the current input video source selected by the end-user display device 14. In this manner, the end user can be notified, e.g., that an electronic message is waiting for the end user at the electronic messaging system connected to the computing device 12, even if the end user currently is watching another video source on the end-user display device 14.

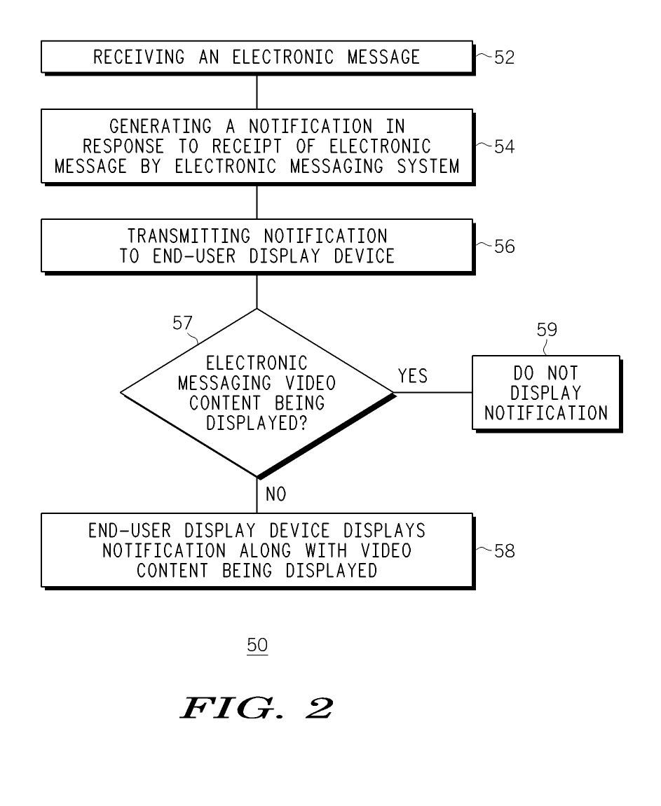

Referring now to FIG. 2, shown is a flow chart of an electronic messaging notification method 50 for end-user display devices. The method 50 will be described with continuing reference to the system 10 shown in FIG. 1. Initially, a step 52 of receiving an electronic message (e.g., an email message, IM message, or electronic chat request or invitation) occurs. The electronic message typically is received by an electronic messaging system residing on the computing device 12 or coupled or connected to the computing device 12, e.g., via an Internet connection or other suitable connection. If the video input source to the end-user display device 14 previously has been selected to be the computing device 12, then an end user currently monitoring the activities of the computing device 12 can and often will be notified of the receipt of an electronic message, e.g., through a standard feature available in conventional electronic messaging programs. However, if an end-user is watching a television program or has video content from another video input device 44 currently displayed on the end-user display device 14, the end-user will not be notified of the receipt of the electronic message.

The method 50 includes a step 54 of the generating a notification in response to the electronic messaging system receiving an electronic message. For example, within the computing device 12, when an electronic message is received, the processor 16 and/or the video card 28 can initiate the execution of a software program, routine or an application program interface (API) that generates a particular notification data portion or signal and embeds it within the information that is generated and transmitted by the computing device 12. Alternatively, the software program, routine or the API can locate an existing notification data portion or signal and associate or embed it within the information generated and transmitted by the computing device 12.

The active video signal is the video (and audio) portion of the signal present at the output of the computing device (or any other A/V or video input device). That is, the active video signal contains the audio and video that is output by the particular computing device and displayed on an end-user display device to which the particular A/V device is connected. For example, for a DVD player, the active video signal is the signal that contains the audio and video content of the DVD's recorded program. The signal also includes other information, such as command and control signals, read and used by the end-user display device.

The notification data portion or signal can be any type or portion of data or signal that is suitable to be read as an alert or notification by a suitable receiver, e.g., a software and/or hardware portion of the I/O interface 34 in the end-user display device 14. For example, the notification data portion or signal can be a control signal and/or an icon or other notification indicia transmitted to the end user display device 14. Alternatively, the notification data portion or signal can be an appropriate instruction or control signal to locate and retrieve an icon and/or other notification indicia stored on the end user display device 14, e.g. in the memory or data storage unit 35. The software program, routine or the API can be located within the computing device 12 (e.g., in the processor 16, the data storage unit 22, and/or the video card 28), or can be located external to the computing device 12 but in operable connection therewith.

The method 50 also includes a step 56 of transmitting the notification to the end-user display device 14. As discussed hereinabove, at least a portion of the notification is a data portion or signal embedded or otherwise made to be part of the information output from the computing device (or other appropriate device) and transmitted to the end-user display device 14, e.g., via an appropriate video input connection between the A/V output of the device and the A/V input of the end-user display device 14. For example, for the computing device 12, the transmission occurs via the connection between the I/O interface 26 of the computing device 12 and the I/O interface 34 of the end-user display device 14.

The method 50 includes a step 57 of determining whether video content from the input video source of the electronic messaging system is being displayed by the end-user display device 14. If video content from the input video source of the electronic messaging system is not being displayed by the end-user display device 14, i.e., if an input video source other than the electronic messaging system is being displayed by the end-user display device 14, the method 50 includes a step 58 of the end-user display device 14 displaying the notification. Moreover, the displaying step 58 includes the end-user display device 14 displaying the notification when video content other than video content from the computing device 12 is displayed on the end-user display device 14. If video content from the input video source of the electronic messaging system is being displayed by the end-user display device 14, the method includes a step 59 of not displaying the notification, since the electronic messaging system usually has some other type of electronic message notification already being displayed.

The end-user display device 14 is equipped with appropriate hardware and/or software and/or firmware or other detection/recognition features to read the notification data portion or signal that is included as part of the information transmitted from the computing device 12 or other appropriate device. For example, the end-user display device 14 can monitor all or a suitable portion of the information transmitted from the computing device 12 to detect the notification data portion. Alternatively, other information transmitted to the end-user display device 14 can be monitored as well for the presence of the notification data portion.

The hardware and/or software and/or firmware or other detection/recognition features are included in the end-user display device 14, e.g., in the I/O interface 34 and/or the video source selector 38. Alternatively, as will be discussed in greater detail hereinbelow, such hardware and/or software and/or firmware or other detection/recognition features can be included in one or more appropriate devices and/or components external to the end-user display device 14.

Upon the detection of the notification data portion or signal in the information output from the computing device 12, the end-user display device 14 displays an appropriate alert message on the screen of the display monitor 42 of the end-user display device 14, regardless of which video source currently is being displayed on (connected to) the end-user display device 14. For example, an appropriate portion of the end-user display device 14 can generate an alert message and have it displayed on the display monitor 42. Alternatively, the end-user display device 14 can locate and retrieve an existing or previously stored alert message and have it displayed on the display monitor 42. The ability to generate or locate an appropriate alert message and display the alert message on the display monitor 42, as described herein, can be derived from appropriate hardware and/or software and/or firmware located either within the end-user display device 14, e.g., in the I/O interface 34 and/or the video source selector 38 or other suitable portion of the end-user display device 14, or external to the end-user display device 14.

The alert message displayed on the display monitor 42 can be any suitable alert message in any suitable form or format. For example the alert message can be a visual alert message, such as an icon, a screen graphic, a flashing light or other suitable visual alert message that is displayed on the screen of the display monitor 42. Alternatively, the alert message can be a text segment that is displayed and/or scrolled across a portion of the display monitor 42. Also, alternatively, the alert message can be an audio signal that is overlayed or otherwise played as part of the audio signal output from the end-user display device 14. The notification audio signal can partially or totally preempt the existing audio signal being output from the end-user display device 14.

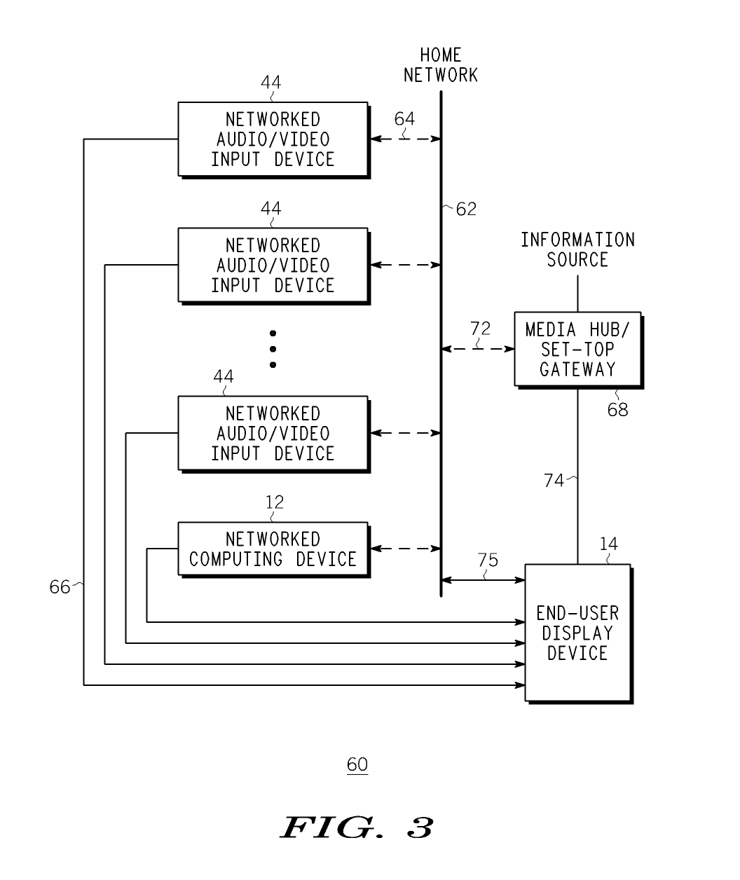

Another type of alert message suitable for notification is a light indicator on the end-user display device 14, such as a flashing light emitting diode (LED). The light can flash periodically when an alert message is waiting. The end user can query the end-user display device 14, e.g., via the remote control device used to operate the end-user display device 14, which video input device was responsible for the alert message. The particular video input device responsible for the alert message can be identified in any suitable manner, e.g., in the form of different icons or other notification indicia for different video input devices. Once the video input device responsible for the alert message is identified, the end user can switch over the end-user display device 14 to that particular video input device. Such feature is useful, e.g., if a plurality of video input devices are being used, as will be discussed in greater detail hereinbelow with respect to the system shown in FIG. 3.

Depending on the detection/recognition feature, and its hardware/software/firmware configuration, the alert message can be displayed for a discrete amount of time or continuously until the end user performs some type of action acknowledging the alert message. For example, the end user can acknowledge the alert message and dismiss it, or turn it off or switch over to the video input source of the computing device 12 and respond to the electronic message or other event that triggered the alert message. Depending on the actions of the end user in responding to the alert message, the computing device 12 or other device can execute an appropriate software program, routine or API that disables the transmission of the notification data portion signal and thus its ability to be embedded in the information output from the device.

In the notification system 10 and method 50 described hereinabove, the end user has the ability to enable or disable the electronic message notification functionality either at the end-user display device 14 and/or at the computing device 12 or in some other suitable manner. Such feature can be provided as a convenience to HDTVs and other high resolution end-user display devices or as part of the computing device or the electronic messaging system to which the computing device is connected.

In the manner described hereinabove, in end-user configurations that include high definition TVs or other high resolution end-user display devices with numerous input connections and a variety of video input devices that can be displayed on it, the notification system and method allows an end user to view video input sources other than the computing device without having to switch over to the computing device display to know whether an electronic message has been received by the electronic messaging system connected to the computing device. Thus, the end user can be notified immediately that an electronic message is waiting for the end user even if the end user is watching another video source on the end-user display device.

Referring now to FIG. 3, shown is a block diagram of an another electronic messaging notification system 60 for end-user display devices. The system 60 includes one or more computing devices 12 and one or more video input devices 44 coupled together as a home network or home network bus or connection (shown generally as 62) via corresponding device network connections 64. The devices 12, 44 also are coupled to the end-user display device 14 via corresponding audio/video (A/V) connections 66.

The home network connection 62 can be any suitable home network connection. Such connections include, e g., a token ring, Ethernet, Fast Ethernet, Gigabit Ethernet, any networking connection technology in accordance with the standards established by the Home Phoneline Networking Alliance (HomePNA or HPNA) or the Multimedia over Coax Alliance (MoCA), the Standard 568 category 1 through 5 according to the American National Standards Institute/Electronic Industries Association (ANSI/EIA), powerline networking, and any networking connection technology in accordance with the IEEE 802.11 standard established by the Institute of Electrical and Electronics Engineers. Also, the home network 62 can be a wired network using Ethernet cables, coaxial cables, fiber optic cables, or a wireless network or any combination thereof. Also, the home network connection can support any number of suitable transmission protocols, including Transmission Control Protocol/Internet Protocol (TCP/IP).

The system 60 also includes a device 68 that serves as a media hub or set-top gateway for the home network 62. As shown, the hub device 68 is connected to the home network 62 via a suitable network connection 72, and also is connected to the end-user display device 14 via a suitable A/V connection 74. Alternatively, the end-user display device 14 can be connected directly to the home network connection 62, e.g., via a suitable connection (shown generally as connection 75).

In the system arrangement or configuration shown in FIG. 3, the media hub or gateway device 68 includes or is in operable connection with appropriate hardware and/or software and/or firmware that allows the media hub or gateway device 68 to be responsible for and perform some or all of the notification functionality previously described hereinabove with respect to the computing device 12 and the end-user display device 14. That is, in general, the media hub or gateway device 68 can provide notification to the end-user display device 14 of the receipt of an electronic message by an electronic messaging system. Also, at least a portion of the messaging system hardware and/or software can be located in the media hub or gateway media hub or gateway device 68. Moreover, in the system 60, the media hub or gateway device 68 can provide notification for any alertable event that occurs in association with any of the video input devices 44 and/or any of the computing devices 12.

The media hub or gateway device 68 is configured to monitor and identify activities and/or events by the computing device 12 and the video input devices 44 that might be suitable for providing notification to the end-user display device 14, e.g., in the manner described hereinabove with respect to the end-user display device 14. For example, assume one of the video input devices 44 receives a programming message from its respective video content source. Because the media hub or gateway device 68 is monitoring the video input device 44 for such events, the media hub or gateway device 68 would detect or identify the programming message and perform some sort of activity, e.g., as described herein, toward notifying the end-user display device 14.

For example, the media hub or gateway device 68 can generate or retrieve an appropriate notification data portion and transmit such notification data portion to the end-user display device 14. The media hub or gateway device 68 can, e.g., transmit the notification data portion to the particular video input device 44 (via network connection 72) in such a manner that the notification data portion becomes part of the information that is supplied by the particular video input device 44 to the end-user display device 14. Alternatively, the media hub or gateway device 68 can provide the notification data portion directly to the end-user display device 14 (via A/V connection 74) with appropriate instructions for displaying its corresponding notification or alert message by the end-user display device 14.

As described hereinabove with respect to the system 10, the notification data portion can be read and any suitable alert message can be displayed on the end-user display device 14 in response thereto. For example, an alert message can be superimposed on the video content that currently is being displayed on the end-user display device 14. Other suitable display techniques can be used.

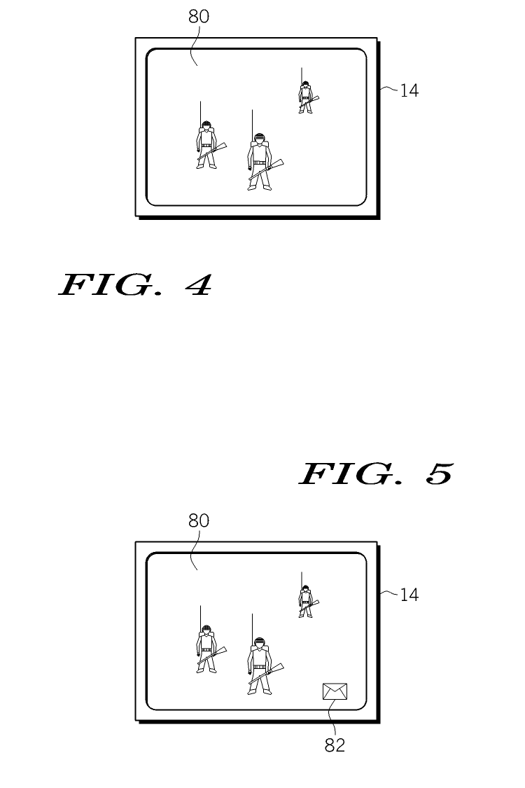

Referring now to FIG. 4, shown is a display screen 80 of an end-user display device 14. The display screen 80 has displayed thereon video content from a video input source. Referring now to FIG. 5, shown is the same display screen 80, but with a notification icon 82 for alerting an end user that an electronic message from an electronic messaging system has been received.

It should be understood that the systems and methods described hereinabove are not limited to notification of the receipt of electronic messages by an electronic messaging system. The systems and methods described hereinabove include providing notification to any computing device, including video input devices, of any event by any one or more of the other computing devices, including other video input devices. Such events include but are not limited to the receipt of data or other information, and the commencement, completion or continuance of time-based events and/or content-based events.

The method described in FIG. 2 may be implemented in a general, multi-purpose or single purpose processor. Such a processor will execute instructions, either at the assembly, compiled or machine-level, to perform that process. Those instructions can be written by one of ordinary skill in the art following the description of FIG. 2 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the electronic messaging notification system and method herein described without departing from the spirit and scope of the invention as defined by the appended claims and their full scope of equivalents.

1. A computer program embodied in a computer-readable medium for providing notification of the receipt of electronic information, the program comprising:
instructions for displaying on an end-user display device a notification of the receipt of the electronic information when the end-user display device is displaying video from a video input source other than the video input source that provided the notification of the receipt of the electronic information, wherein the end-user display device has switchably coupled thereto a plurality of video input sources.

2. The computer program as recited in claim 1, wherein the displaying instructions display the notification of the receipt of the electronic information on the end-user display device in response to a computing device coupled to the end user display device generating and transmitting to the end-user display device the notification of the receipt of the electronic information in response to an electronic information system receiving the electronic information.

3. The computer program as recited in claim 1, wherein the displaying instructions include instructions for providing an alert message that can be displayed on the end-user display device regardless of the video content being displayed on the end-user device.

4. The computer program as recited in claim 1, wherein the displaying instructions include instructions for generating a visual alert message that can be displayed by the end-user display device.

5. The computer program as recited in claim 1, wherein the displaying instructions include instructions for generating an audio signal that can be audibly played by the end-user display device.

6. The computer program as recited in claim 1, wherein the electronic information further comprises an electronic message selected from the group consisting of an electronic mail (email) message, an instant messaging message, an electronic chat request, and an electronic chat invitation.

7. An apparatus for providing notification of a received electronic message, the system comprising:
an end-user display device coupled to a plurality of video input sources including a video input from a computing device having an electronic messaging system coupled thereto,
wherein the end-user display device includes a plurality of input interface connections that allow the end-user display device to switchably receive a video input from one of the plurality of video input sources, and
wherein, upon the receipt of an electronic message by the electronic messaging system, the end-laser display device receives and displays notification of receipt of the electronic message by the electronic messaging system when the end-user display device is displaying video from a video input source other than the computing device.

8. The apparatus as recited in claim 7, wherein the end-user display device displays the notification of receipt of the electronic message by overlaying the notification on the video being displayed from a video input source other than the computing device.

9. The apparatus as recited in claim 7, wherein the end-user display device displays a visual alert notification in response to the receipt of the electronic message.

10. The apparatus as recited in claim 7, wherein the end-user display device generates an audio alert notification in response to the receipt of the electronic message.

11. The apparatus as recited in claim 7, wherein the end-user display device further comprises a television.

12. The apparatus as recited in claim 7, wherein the end-user display device further comprises a high definition television (HDTV).

13. The apparatus as recited in claim 7, wherein the end-user display device further comprises a computer.

14. A computer program embodied in a computer-readable medium for providing notification of the receipt of electronic information, the program comprising:
instructions for generating by a computing device a notification of the receipt of the electronic information by an electronic information system coupled to the computing device, in response to the electronic information system receiving the electronic information; and
instructions for transmitting the notification of the receipt of the electronic information to an end-user display device coupled to the computing device,
wherein the end-user display device has switchably coupled thereto a plurality of video input sources including a video input from the computing device, and
wherein the end user display device is configured to display the notification of the receipt of the electronic information when the end-user display device is displaying video from a video input source other than the computing device.

15. The computer program as recited in claim 14, wherein the generating instructions further comprise instructions for embedding notification data in a video signal that can be transmitted to and read by the end-user display device in such a way that an alert message can be displayed on the end-user display device regardless of the video content being displayed on the end-user device.

16. The computer program as recited in claim 14, wherein the computing device notifies the end-user display device of receipt of the electronic information by providing a visual alert message that can be displayed by the end-user display device.

17. The computer program as recited in claim 14, wherein the computing device notifies the end-user display device of receipt of the electronic information by providing an audio alert signal that can be played audibly by the end-user display device.

18. The computer program as recited in claim 1, wherein the electronic information further comprises an electronic message selected from the group consisting of an electronic mail (email) message, an instant messaging message, an electronic chat request, and an electronic chat invitation
